(19) United States
(12) Patent Application Publication
(10) Pub. No.: US 2008/0242415 A1
(43) Pub. Date: Oct. 2, 2008

(54) MOTION-BASED INPUT FOR PLATFORMS AND APPLICATIONS

(76) Inventor: Nazeer Ahmed, Kirkland, WA (US)

Correspondence Address: PERKINS COIE LLP;PATENT-SEA, P.O. BOX 1247, SEATTLE, WA, 98111-1247, US

(21) Appl. No.: 11/740,173

(22) Filed: Apr. 25, 2007

Related U.S. Application Data
(60) Provisional application No. 60/908,368, filed on Mar. 27, 2007.

(51) Int. Cl. A63F 13/00

(52) U.S. Cl. 463/39; 340/686.1

(57) ABSTRACT

The flexible motion system simplifies the process of adding motion-based input to an application. The flexible motion system uses a motion detection device to detect motion based on the movement of an object. Next, the flexible motion system converts the motion detected by the motion detection device into input recognized by the application, and provides this input to the application. The motion may be converted using a grammar specified by an application developer through an updateable action pack.

### CROSS-REFERENCE TO RELATED APPLICATIONS

The present application claims priority to U.S. Provisional Patent Application No. 60/908,368 (Attorney Docket No. 63829-8001.US00) entitled “MOTION-BASED INPUT FOR PLATFORMS AND APPLICATIONS,” and filed on Mar. 27, 2007, which is hereby incorporated by reference.

### BACKGROUND

A video game (or videogame) is an application that typically involves user/player interaction with a controller interface to generate visual feedback on a video screen. The various types of electronic devices that players use to play video games are known as platforms. A few examples of platforms are personal computers (PCs), video game consoles, arcade machines, and casino gaming machines. Video game platforms exist across a full range of devices ranging from large computers (such as mainframes) down to smaller hand-held devices (such as cell phones and portable digital assistants (PDAs)).

Players generally manipulate video games through a control interface, called a controller, which varies across platforms. Some examples of controllers are a keyboard, mouse, joystick, racing wheel, light gun, gamepad, paddle, and trackball. For instance, a proprietary platform controller might consist of only a button and a joystick or feature upwards of a dozen buttons and one or more joysticks all on the same controller. Early computer-based games relied on the availability of a keyboard for game play, or sometimes expected the player to purchase a separate joystick with at least one button to play. Many modern PC games allow the player to use a keyboard and mouse simultaneously.

The primary goal of the different types of controllers is to provide the player with a feeling of being in the game, sometimes called immersion, which creates a more realistic experience. Unfortunately, the controller concept is over 25 years old, and often provides an unrealistic experience for the player. For example, a player may be required to push a button to swing a virtual baseball bat in a baseball video game, which has no analog in the real game of baseball. Many games have become so complex that a player must spend a large amount of time learning a control scheme to perform actions that she has no trouble performing in real life, such as jumping, running, kicking a ball, and so on. In addition, traditional controllers are unhealthy, because they encourage sedentary behavior. Players often sit in a seat for hours using a traditional controller. Studies show that the average game player plays games seven hours per week and children who spend more time playing video games are more likely to be classified as overweight or obese. Using traditional controllers creates guilt in the game player for sitting too much and upsets parents that want to encourage a more active lifestyle in their children.

More recently, realistic controllers have received substantial success. For example, games such as Dance Dance Revolution (in which a player dances on a series of squares in a controller laying on the floor) and Guitar Hero (in which a player plays a realistic looking guitar controller to progress through a game) have won numerous awards and achieved millions of dollars in sales. Newer game platforms have provided motion-based controllers that a player holds and moves around to interact with a game. However, all of these controllers support only a single platform, and require game developers to modify the game to use the controller. Each platform that a player uses generally has a different controller, requiring the player to learn new controls every time the player switches platforms. For example, a player will generally use a keyboard and mouse on a PC, a proprietary controller on a game console, a number pad on a cell phone, and so on. Moreover, requiring game publishers to specifically develop their games to support special controllers has been unsuccessful. Game publishers often have tight budgets and there is often little time left at the end of a development cycle to add support for a controller that only some of the gaming market will own.

### BRIEF DESCRIPTION OF THE DRAWINGS

FIG. 1 is a block diagram that illustrates components of the flexible motion system in one embodiment.

FIG. 2 is a flow diagram that illustrates the processing of the components of the flexible motion system in one embodiment.

FIG. 3 is a flow diagram that illustrates the processing of the action pack component to add new configuration information to the flexible motion system in one embodiment.

FIG. 4 is a block diagram that illustrates an environment in which the flexible motion system is used in one embodiment.

### DETAILED DESCRIPTION

The following description provides a method and system for enhancing applications with motion-based input, called the flexible motion system. The flexible motion system comprises a motion detection device, a motion processor, and a communication interface. The motion detection device may include one or more satellite controllers communicating with an application platform. The flexible motion system makes it easy for application developers to add support for a motion detection device to a game or other application. For example, rather than requiring the game to understand various types of motion and detect when combinations of motion that are interesting to the application have occurred, the flexible motion system allows the game developer to define his own grammar of motion, and receive interpreted motion from a motion detection device. For example, a racing game developer can define motions to the left and right along one axis to represent left turn and right turn interpreted words of motion. Rather than handling input in the form of motion along a particular axis, or acceleration values from an accelerometer, the flexible motion system provides the application with input in a form that the application understands. The system is similar to language, in which sounds are used to make letters, letters make up words, and words form sentences that have meaning. Similarly, the flexible motion system interprets individual movements, acceleration, and other motion-based input (similar to sounds) into letters, and combinations of motions into words, and then provides the interpreted input to the application. Thus, the flexible motion system simplifies the process of adding motion-based input to an application.

In some embodiments, the flexible motion system can be used to add support for motion-based input to an application that has not been specifically designed to receive motion-based input. For example, the flexible motion system may identify a game designed to receive input from the mouse and keyboard of a personal computer, where the developer did not anticipate having the game receive motion-based input. The flexible motion system uses a motion detection device to detect motion based on the movement of an object. For example, a person may attach a motion detection device to his wrist, and the device may detect when the person moves his wrist. Next, the flexible motion system converts the motion detected by the motion detection device into input recognized by the application. For example, if the application is designed to receive input representing the “up” arrow of a keyboard to indicate that a player wants to move a character forward in a game, then the flexible motion system may convert a flick of the player's wrist upwards into an input that is received by the application as if the player pressed the “up” arrow of the keyboard. The flexible motion system provides this input to the application. Thus, users can use a motion detection device to interact with applications that were not specifically designed to receive motion-based input. For example, a player could play a boxing game by attaching a motion detection device to each wrist and actually punching as in real boxing.

A player using the flexible motion system is more active than a player using a traditional controller is and may even improve his health while playing games. This may create new markets for gaming such as bored exercisers, parents wanting to make kids more active, gym professionals that can use gaming platforms for training, and healthcare professionals that can use gaming platforms for physical therapy and other rehabilitation. The flexible motion system is backwards compatible and can be used with existing games.

### Motion Detection Device

In some embodiments, the flexible motion system operates across gaming platforms. For example, a player can use the flexible motion system with a PC, a gaming console, or other gaming platforms. A player that is familiar with using a device based on the flexible motion system on one platform does not have to re-learn the control interface to use another platform.

In some embodiments, the flexible motion system utilizes off-the-shelf components. For example, the motion detection device may contain an accelerometer, tilt meter, gyroscope, or other commonly available motion detecting devices. The motion detection device may communicate wirelessly with the gaming platform using a variety of wireless interfaces, such as Bluetooth or Zigbee. Some wireless interfaces may be built into the gaming platform, such that the flexible motion system is contained within a controller, while other wireless interfaces may utilize a dongle and controller, where the dongle receives transmissions from the controller. The control logic for converting movement to game controls may be contained in a microcontroller, such as the Freescale MCU microcontroller.

In some embodiments, the flexible motion system includes more than one motion detection device. For example, the flexible motion system may include a motion detection device that the player can hold in each hand or strap to each wrist. This allows the player to use more of her natural motion to interact with a game, and allows the flexible motion system to detect more of the player's movements.

In some embodiments, a player can attach the motion detection device to objects or parts of the body. For example, a player may attach the motion detection device to common objects such as a toy sword for use in a fighting game, or a Frisbee for use as a steering wheel in a racing game. Thus, the flexible motion system allows a player to create a more realistic gaming environment limited only by the player's imagination and creativity. The player may also wear motion detection devices at various locations of the body such as elbows, wrists, knees, and so on, such that the flexible motion system can detect very fine-grained types of movement. For example, the flexible motion system may detect when the player is running, kicking, or waving. A player may even attach a motion detection device to other moving objects not attached to the player, such as a ball that the player throws, or a pet with which the player jogs. The controller may also be used to detect other types of motion, such as an earthquake or volcanic activity.

In some embodiments, multiple motion detection devices are configured to work with the flexible motion system as a mother and one or more child motion detection devices. For example, one motion detection device attached to the player's wrist may be designated the mother motion detection device, while other motion detection devices attached to the player's elbows, knees, and so forth may be designated as child motion detection devices. The mother motion detection device may gather movement information from each of the child motion detection devices before sending input to the gaming platform, or each of the motion detection devices may communicate with the gaming platform directly. This type of configuration can overcome limitations of the number of devices that can be connected at once via some communication technologies, such as Bluetooth, through which some gaming platforms receive input.

### Power Saving

In some embodiments, the flexible motion system reduces power consumption by configuring the hardware not to send all motions to the gaming platform. For example, a motion detection device may be configured to ignore movements having a magnitude that falls below a certain threshold. Because it is difficult to hold the motion detection device perfectly still, the flexible motion system may always detect some motion. However, until the player has moved the motion detection device a significant amount, the flexible motion system may ignore the movement. The appropriate level of movement that is significant may be predetermined when the device is manufactured or determined dynamically by the flexible motion system. For example, the configuration software may walk the player through a series of configuration steps designed to determine the movement threshold. The movement threshold may also be determined heuristically based on the player's use of the motion detection device. Thresholds may be set differently for different types or directions of movement. For example, a motion detection device that detects movement along x, y, and z-axes may have a different threshold for movement along each of the three axes.

A player may use the flexible motion system in environments, such as in a wireless controller for a gaming platform, where battery life is important to the operation of the device. By reducing the power consumed, the flexible motion system increases battery life. The flexible motion system may also reduce the size of the battery needed by reducing power consumption, making the motion detection device lighter, easier to use, and cheaper to manufacture.

In some embodiments, the flexible motion system does not send movements that are not relevant to a particular game. For example, a racing game may only utilize left and right rotating movements similar to the turning of a steering wheel, and the flexible motion system may ignore movement in the z-axis direction. The wireless hardware of a device consumes a significant amount of the power used by the device, so reducing the amount of information sent over the wireless connection can result in a meaningful reduction in the power consumption of the device.

In some embodiments, the flexible motion system converts movements into defined input values, to quantify the direction or level of intensity with which the motion detection device was moved. For example, the flexible motion system may provide an enumeration of possible input values that correspond to common types of motion, such as up, down, and so forth. The input values may also define a level of magnitude (e.g., from one to 10), such as up 10, up five, and so on.

In some embodiments, the flexible motion system allows an application developer to define a grammar of motion that describes how detected motion should be converted into input recognized by the application. The system is similar to language, in which sounds are used to make letters, letters make up words, and words form sentences that have meaning. Similarly, the flexible motion system interprets individual movements, acceleration, and other motion-based input (similar to sounds) into letters, and combinations of motions into words, and then provides the interpreted input to the application. An application developer may define various levels of motion. For example, the application developer may define motion “letters” that represent low-level movements, such as move right and move left. The application developer may also define motion “words” that represent higher-level movements, such as kick and punch, which are made up of more than one motion “letter.” For example, the flexible motion system may interpret an upward swinging motion from a motion detection device attached to a user's foot as a kick, based on information provided by the application developer. In addition, the application developer may define motion “sentences” that represent combinations of high-level movements. For example, the developer of a fighting game may define two left punches followed by a right punch as a combination move that earns the player extra points. The application developer may specify the grammar for interpreting motion in a Backus-Naur form (BNF) or other common method for specifying grammars. The application developer may provide the grammar in an action pack, as described further below.

### Action Packs

In some embodiments, the flexible motion system may be configured to operate with various games. A player may perform the configuration using software or hardware. For example, the flexible motion system may include a software utility for mapping various motions to keyboard keys or control-pad buttons. The software utility may select a mapping automatically, such as based on a particular application that is running, or may provide a user interface that allows a user to specify an appropriate mapping. Similarly, the flexible motion system may include programmable firmware within the motion detection device that a user can update with mappings for popular games or control schemes.

In some embodiments, the flexible control system receives updated game mappings through action packs. An action pack may contain information about the controls typically used to operate one or more games and the type of movement received by the motion detection device that the flexible motion system should map to each of the controls. For example, first person shooter (FPS) games often use the W, A, S, and Z keys of a computer keyboard for moving a character up, left, right, and down, respectively. An action pack for FPS games may map the physical up, left, right, and down motion of the motion detection device to inputs that simulate the W, A, S, and Z keys of the computer keyboard. Action packs may be loaded through software into the firmware of a motion detection device.

In some embodiments, the flexible motion system receives action packs from the gaming community. For example, players may create and upload action packs that other players can download. Alternatively or additionally, the manufacturer of the motion detection device may create action packs and make them available to players. Action packs free the game publisher from needing to perform extra work to support a motion detection device based on the flexible motion system. Support for games can grow based on the popularity of the game and the willingness of the gaming community to provide support for a motion-based device. The flexible motion system can even provide motion-based input for old games that are no longer in production.

In some embodiments, action packs use a grammar and action language designed for motion-based devices. For example, the language may define keywords for directions of movement (such as up, down, left, and right), types of movement (rotating, jerking, or swinging the motion detection device), and so forth. The language may also provide various traditional inputs that the action pack maps the movements to, such as keyboard keys, mouse movements, gamepad buttons, and so on.

### Figures

The following description further illustrates the flexible motion system described above with reference to the figures. These figures are only examples, and those of ordinary skill in the art will appreciate that various modifications can be made without departing from the scope and spirit of the flexible motion system described herein.

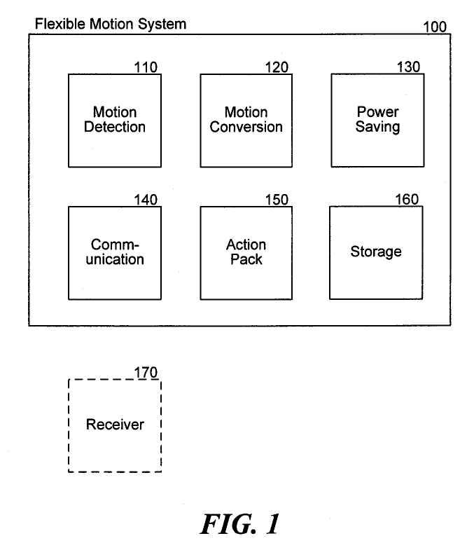

FIG. 1 is a block diagram that illustrates components of the flexible motion system in one embodiment. The flexible motion system 100 contains a motion detection component 110, a motion conversion component 120, a power saving component 130, a communication component 140, an action pack component 150, and a storage component 160. FIG. 1 also contains an example receiver component 170 with which the flexible motion system 100 communicates. The motion detection component 110 detects movements by a player using the flexible motion system. The motion detection component 110 may contain gyroscopes, accelerometers, and other motion detecting devices that capture and quantify motion. The motion conversion component 120 converts movements into input recognized by one or more applications. For example, the motion conversion component 120 may convert upward movement into a keyboard key or mouse movement. The motion conversion component 120 may contain a set of mappings that map particular types of movements to particular input values. The power saving component 130 optimizes the communication of the flexible motion system 100 by discarding movements below a particular threshold or that are not relevant for a particular type of game. The communication component 140 uses communication technologies, such as Bluetooth or Zigbee, to communicate with the receiver component 170 of a gaming platform such as a game console or PC. The communication component 140 may also communicate with other motion-based devices, such as the mother/child configuration described herein. The action pack component 150 receives mappings for particular games or types of games and applies them to the motion conversion component 120 to modify the behavior of the flexible motion system 100. The storage component 160 stores mappings between uses of the flexible motion system 100. The receiver component 170 may include a dongle that is provided with the flexible motion system 100, or may include a component built into a gaming platform, such as a Bluetooth receiver.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

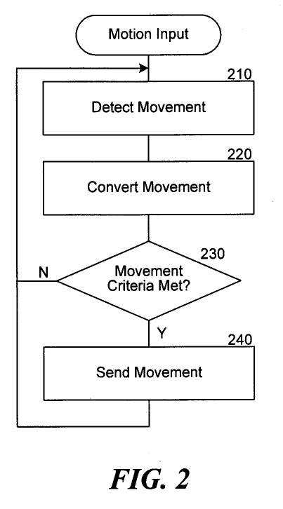

FIG. 2 is a flow diagram that illustrates the processing of the flexible motion system in one embodiment. In block 210, the motion detection component 110 detects movement of the flexible motion system, such as by reading a motion sensor input value. In block 220, the motion conversion component 120 converts the movement detected by the motion detection component 110 into the type of input expected by an application. For example, the flexible motion system may process the sensor input value to aggregate multiple motions into one or more inputs for the application, filter out certain types of motion, or interpret the detected motion in some other way that is useful for the application. Motion can be converted into multiple concurrent inputs (such as Ctrl+F, Alt+W, or Up Arrow+Left Arrow), a series of control inputs (such as “A”+“A”+“D”), a control input with a duration (such as space bar for 1200 ms OR Ctrl key for as long as motion continues), and so forth. The flexible motion system can pass input to the application in the form of control inputs or function calls. The flexible motion system may specify the rules for converting the movement into application input, for example, in an action pack. In decision block 230, if the movement satisfies a movement criterion, then the component continues to block 240, else the component discards the movement and loops to block 210 to detect more movement. The movement criterion may be a threshold or other criterion that must be satisfied before the flexible motion system will transmit the application control information to a receiving platform. In block 240, the flexible motion system sends the processed input information to a receiving device using the communication component 140. The flexible motion system then loops to block 210 to detect and process additional movement.

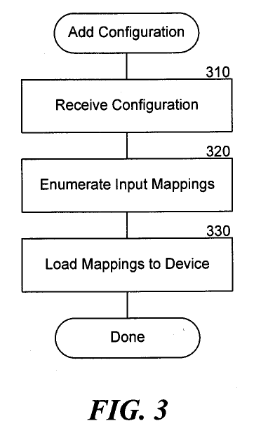

FIG. 3 is a flow diagram that illustrates the processing of the action pack component to add new motion conversion information to the flexible motion system in one embodiment. Action packs may be provided, for example, as downloadable software from the Internet that the user uses to update the flexible motion system, or may be provided through a hardware device (such as a flash memory) that is inserted by the user into a controller using the flexible motion system. In block 310, the component receives motion conversion information. In block 320, the component enumerates the input mappings contained within the motion conversion information. For example, the motion conversion information may contain a table of movement values to map to particular input values, or the motion conversion information may contain a specification of mappings in an action pack-specific language. In block 330, the component loads the mappings into the motion detection device that contains the flexible motion system. This step may involve updating a firmware component or other storage component that stores the configuration of the device. After block 330, these steps conclude.

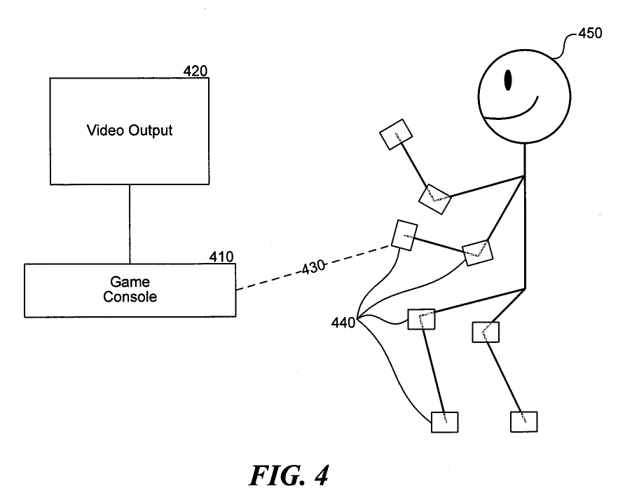

FIG. 4 is a block diagram that illustrates an environment in which the flexible motion system is used in one embodiment. The diagram illustrates a game platform 410, a video output device 420, a wireless communication link 430, several flexible motion system-based motion detection devices 440, and a player 450. The player 450 is wearing multiple flexible motion system-based motion detection devices 440 that detect various types of movements made by the player 450. For example, the motion detection devices 440 can detect when the player 450 makes a kicking or punching motion. The game platform 410 receives input over the wireless communication link 430 based on the motion conversion information currently loaded by the motion detection device. For example, if the game platform 410 is designed for a controller with A, B, X, and Y buttons, then the movements of the player 450 may be converted into input similar to that produced by pressing one of these buttons. The player 450 sees the effect of his movements on the game through the video output device 420.

The motion detection devices 440 may work together to provide motion-based input to the game platform 410. For example, one or more child controllers may provide motion information to a mother controller. Each child controller may provide interpreted motion input based on its own motion conversion information, or each child controller may provide raw movement data to the mother controller. The mother controller summarizes the movement information from each child controller and applies motion conversion information stored at the mother controller to the input to produce interpreted movement information to the gaming platform 410. For example, a child controller on a user's foot may detect acceleration in an upward motion and interpret this movement as a kick. A child controller on the user's wrist may detect forward acceleration and interpret this movement as a punch. The mother controller receives input from each of these child controllers and may deliver the information to the gaming platform 410 as a single kick-punch combination movement understood by an application running on the gaming platform 410.

### CONCLUSION

From the foregoing, it will be appreciated that specific embodiments of the flexible motion system have been described herein for purposes of illustration, but that various modifications may be made without deviating from the spirit and scope of the invention. Although the preceding description illustrates the use of the flexible motion system in a gaming environment, applications may use the flexible motion system in many environments. For example, home fitness machines may use the flexible motion system for counting calories or detecting participation in an exercise video. Training professionals may use the flexible motion system to improve training of their clients. For example, a golf trainer may use the flexible motion system to improve a client's golf swing or in other sports where training and practice are helpful to master essential skills. As another example, medical professionals may use the flexible motion system to assist patients to complete physical therapy exercises. Accordingly, the invention is not limited except as by the appended claims.

I/We claim:

1. A method of adding motion-based control to an application operating on a platform, the method comprising:
detecting motion based on the movement of an object received from a motion detecting device;
mapping the detected motion to control information recognized by an application, wherein the mapping is based on a motion grammar;
transmitting the control information to the platform on which the application is operating.

2. The method of claim 1 wherein the motion detecting device includes at least one of an accelerometer, gyroscope, and electronic compass.

3. The method of claim 1 wherein transmitting the control information comprises transmitting the control information over a wireless link.

4. The method of claim 1 wherein the motion detecting device is embodied in a satellite controller that includes a wireless communication unit and programmable microcontroller.

5. The method of claim 4 wherein the satellite controller contains upgradeable firmware.

6. The method of claim 1 wherein the movement is detected from multiple objects having attached satellite controllers including motion detecting devices.

7. The method of claim 6 wherein the motion detecting devices are attached to part of the body of a user.

8. The method of claim 6 wherein the motion detecting devices are attached to at least one of a human, a non-human living species, a machine, and a natural phenomenon.

9. The method of claim 6 wherein the satellite controllers communicate wirelessly through one or more wireless communication devices.

10. The method of claim 9 wherein the satellite controllers are organized in groups and each group communicates through a separate wireless communication device with the application.

11. The method of claim 9 wherein the wireless communication devices operate using at least one of 802.15.4, Bluetooth, Wi-Fi, infrared, and Zigbee.

12. The method of claim 9 wherein the wireless communication devices communicate with a dongle attached to the application platform.

13. The method of claim 12 wherein the dongle comprises at least one of a USB dongle, proprietary controller dongle, keyboard dongle, and mouse dongle.

14. The method of claim 1 wherein the motion grammar specifies rules for converting a combination of movements into one or more inputs for the application.

15. The method of claim 1 wherein the motion grammar is a BNF grammar.

16. The method of claim 1 wherein the application is a game.

17. The method of claim 1 wherein the application is a fitness application.

18. The method of claim 1 wherein the device is operated by a person and wherein the moving object is a part of the person's body.

19. A method of adding motion-based input to an application, the method comprising:
identifying an application that is not configured to receive input from a motion detection device, wherein the application is configured to receive input from a device that is not based on detecting motion;
detecting motion based on the movement of an object received from a motion detecting device;
converting the detected motion to input recognized by the application; and
providing the input to the application.

20. The method of claim 19 wherein the application is a game.

21. The method of claim 19 wherein the application is a fitness application.

22. The method of claim 19 wherein the device is operated by a person and wherein the moving object is a part of the person's body.

23. The method of claim 19 wherein the moving object is a toy to which a motion detection device is attached.

24. The method of claim 19 wherein the application is configured to receive input from a game console controller and wherein converting the detected motion comprises converting the detected motion into inputs produced by the game console controller.

25. The method of claim 19 wherein the application is configured to receive input from a keyboard or mouse and wherein converting the detected motion comprises converting the detected motion into inputs produced by a keyboard or mouse.

26. The method of claim 19 wherein detecting motion comprises receiving the output of an accelerometer.

27. The method of claim 19 wherein converting the detected motion comprises mapping the detected motion to a predefined set of input values.

28. The method of claim 19 wherein providing the input to the application comprises sending the input over a wireless link.

29. The method of claim 19 wherein detecting motion comprises receiving input from multiple motion detecting devices.

30. A computer-readable medium containing instructions for controlling a computer system to reduce the power consumption of a motion detecting device embedded in a game controller, by a method comprising:
detecting a motion sensor input in a game controller based on the movement of an object;
comparing the motion sensor input to a movement criteria; and
when the motion sensor input satisfies the movement criteria, sending an indication of the motion to a receiving device.

31. The computer-readable medium of claim 30 wherein the movement criteria is a threshold level of movement.

32. The computer-readable medium of claim 31 wherein the threshold is determined dynamically.

33. The computer-readable medium of claim 30 including processing the detected motion sensor input to convert the motion sensor input to an aggregated motion input value.

34. The computer-readable medium of claim 30 wherein the movement criteria is based on an application that receives the indication.

35. A computer system for providing a game controller that can be used with multiple gaming platforms through upgradeable action packs, comprising:
a motion detecting component configured to detect movement of a device containing the system;
a motion converting component configured to convert detected movement to at least one defined input value based on one or more input mappings; and
an action pack loading component configured to load an action pack containing input mappings.

36. The system of claim 35 wherein an action pack contains a set of input mappings for controlling a particular game.

37. The system of claim 35 wherein the action pack loading component modifies a firmware component.

38. The system of claim 35 wherein the action pack is created by a player.
